(19) United States
(12) Patent Application Publication
(10) Pub. No.: US 2017/0098269 A1
(43) Pub. Date: Apr. 6, 2017

(54) METHOD FOR PROVIDING NECESSARY INFORMATION BASED ON CHATTING DOCUMENTS

(71) Applicant: ScatterLab Inc., Seoul (KR)

(72) Inventor: Jong Youn Kim, Seoul (KR)

(21) Appl. No.: 15/235,419

(22) Filed: Oct. 20, 2016

(30) Foreign Application Priority Data
Aug. 12, 2015 (KR) 10-2015-0114090

(51) Int. Cl. G06Q 30/06; G06Q 10/10; H04L 12/58

(52) U.S. Cl. CPC G06Q 30/0633; H04L 51/046; G06Q 10/1097

(57) ABSTRACT

Provided is an artificial intelligence chat method for providing necessary information based on chatting documents. The artificial intelligence chat method for providing necessary information based on the chatting documents proposed at the inventive concepts method may include collecting, in real time, chatting documents related data between a user and a counterpart and chat type related data in conjunction with a chat application to analyze a morpheme, parameterizing and storing the chatting documents related data and the chat type related data based on the analyzed result, evaluating a value of the chatting documents between the user and the counterpart by using the parameterized and stored chatting documents related data and the parameterized and stored chat type and manufacturing the necessary information according to the evaluation in a card form that includes monitoring, a wishlist service, an advice service, an important message service, a keyword history, and a schedule service, and notifying the user and the counterpart of the manufactured card form.

### CROSS-REFERENCE TO RELATED APPLICATION(S)

This application claims the benefit under 35 U.S.C. §119(a) of a Korean patent application filed on Aug. 12, 2015 in the Korean Intellectual Property Office and assigned Serial number 10-2015-0114090, the entire disclosure of which is hereby incorporated by reference.

### TECHNICAL FIELD

Embodiments of the inventive concepts described herein relate to an artificial intelligence chat for providing necessary information based on chatting documents.

### BACKGROUND

In recent years, with the development of a wireless/wired internet, electronic commerce through the wireless/wired internet is significantly increasing. Due to increase in commerce of the wireless/wired internet and an explosion in the number of users, a wireless/wired internet content provider is trying to attract users by providing a variety of communities. Generally, a chat service, a messenger service, a short message service, and the like are provided.

According to the related art, a system and a method of interworking with an instance messenger on a web may provide optimized information regardless of whether a user performs a web browser, by operating various services, for example, a game provided on a web, an electronic commerce service, an information provision service, a meeting chance provision service, and the like in conjunction with a message transmission/reception function of an instance messenger service and may request a user input based on the provided information.

One of the various services needs a method and a system for searching for necessary information, which a user and a chat counterpart want, based on chatting documents and providing a product or a service based on the necessary information. Provided is the method for precisely recognizing a variety of situations by providing the necessary information to each other based on the chatting documents, notifying each other of appropriate information, and providing notification of an action that exerts a negative influence on a relation between the user and the counterpart.

### SUMMARY

Embodiments of the inventive concepts provide a method and system for providing each other with necessary information based on chatting documents between a user and a counterpart in conjunction with a chat application.

In one aspect of embodiments of the inventive concept, an artificial intelligence chat method for providing necessary information based on chatting documents includes collecting, in real time, chatting documents related data between a user and a counterpart and chat type related data in conjunction with a chat application to analyze a morpheme of the chatting documents related data, parameterizing and storing the chatting documents related data and the chat type related data based on the analyzed result, evaluating a value of the chatting documents between the user and the counterpart by using the parameterized and stored chatting documents related data and the parameterized and stored chat type and manufacturing the necessary information according to the evaluation in a card form that includes monitoring, a wishlist, an advice service, an important message service, a keyword history service, and a schedule service, and notifying the user and the counterpart of the manufactured card form.

The monitoring service may recognize situation information including conditions, feelings, and daily patterns of the user and the counterpart based on the parameterized and stored chatting documents related data and the parameterized and stored chat type and may provide the necessary information corresponding to the situation information.

The wishlist service may recognize a message having wish information including a place where the user and the counterpart want to go, food that the user and the counterpart want to eat, and a task, which the user and the counterpart want to do, based on the parameterized and stored chatting documents related data and the parameterized and stored chat type and may store the wish information in the wishlist service.

The advice service may recognize negative information that exerts a negative influence on a relation between the user and the counterpart based on the parameterized and stored chatting documents related data and the parameterized and stored chat type and may allow the user to reduce a mention of the negative information.

The important message service may store a message, which is worthy of storage, as an important message if the message between the user and the counterpart, which is worthy of storage, is sent and received based on the parameterized and stored chatting documents related data and the stored chat type related data.

The keyword history service may recognize a subject of a message between the user and the counterpart based on the parameterized and stored chatting documents related data and the parameterized and stored chat type and may arrange and store the subject for each preset interval.

The schedule service may recognize a schedule from a message between the user and the counterpart based on the parameterized and stored chatting documents related data and the parameterized and stored chat type and may arrange and store the schedule.

The method may include collecting, in real time, the chatting documents related data including a keyword, a tone, and a subject of the chatting documents between the user and the counterpart and the chat type related data including a response time and a message length of the chatting documents between the user and the counterpart and analyzing each morpheme.

The method may include parameterizing the chatting documents related data and the chat type related data into metadata based on the analyzed result and storing the metadata.

The method may further include recommending the necessary information to the user and the counterpart by using the parameterized and stored chatting documents related data and the parameterized and stored chat type and providing the recommended information to the user or the counterpart in conjunction with social commerce.

The providing of the recommended information to the user or the counterpart in conjunction with the social commerce may include providing a user interface (UI) such that the user immediately purchases a product or presents the product to the counterpart based on the necessary information corresponding to a situation of the user and the counterpart and interworking with the social commerce through the UI.

According to embodiments of the inventive concept, the method and the system may precisely recognize a variety of situations by providing necessary information to each other based on chatting documents between the user and the counterpart and may notify each other of appropriate information based on the recognized result. Furthermore, the method and the system may provide notification of an action that exerts a negative influence on a relation and may allow the user to reduce the action.

### BRIEF DESCRIPTION OF THE DRAWINGS

FIG. 1 is a drawing for schematically describing a relation between a user terminal and an artificial intelligence chat system, according to an embodiment of the inventive concept.

FIG. 2 is a flowchart for describing an artificial intelligence chat method of providing necessary information based on chatting documents, according to an embodiment of the inventive concept.

FIG. 3 is a drawing for describing a process of interworking with a chat application, according to an embodiment of the inventive concept.

FIG. 4 is a drawing for describing a process of manufacturing necessary information in a card form, according to an embodiment of the inventive concept.

FIG. 5 is a drawing for describing a process of providing necessary information, according to an embodiment of the inventive concept.

FIG. 6 is a drawing for describing a monitoring process, according to an embodiment of the inventive concept.

FIGS. 7A and 7B are drawings for describing processes of storing a wishlist, according to embodiments of the inventive concept.

FIG. 8 is a drawing for describing a process of providing an advice service, according to an embodiment of the inventive concept.

FIG. 9 is a drawing for describing a process of providing an important message service, according to an embodiment of the inventive concept.

FIG. 10 is a drawing for describing a process of providing a keyword history service, according to an embodiment of the inventive concept.

FIGS. 11A and 11B are drawings for describing processes of providing a schedule service, according to an embodiments of the inventive concept.

FIG. 12 is a drawing illustrating a configuration of an artificial intelligence chat system providing necessary information based on chatting documents, according to an embodiment of the inventive concept.

### DETAILED DESCRIPTION

Hereinafter, a description will be given in detail for exemplary embodiments of the inventive concept with reference to the following drawings.

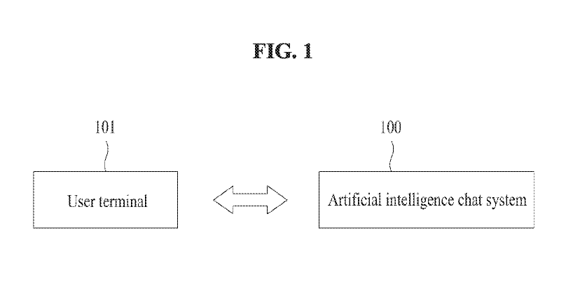

FIG. 1 is a drawing for schematically describing a relation between a user terminal and an artificial intelligence chat system, according to an embodiment of the inventive concept.

FIG. 1 illustrates an artificial intelligence chat system 100 and a user terminal 101. An arrow in FIG. 1 may mean that data is sent and received over wired/wireless network between the artificial intelligence chat system 100 and the user terminal 101.

The user terminal 101 may be a personal computer (PC), a smartphone, a tablet PC, or the like and may mean that all terminal devices capable of connecting with a web/mobile site associated with the artificial intelligence chat system 100 or installing and performing a service dedicated application. In this case, the user terminal 101 may perform overall service operations of configuring a service screen, inputting data, sending and receiving data, storing data, and the like under control of the web/mobile site or the dedicated application.

The artificial intelligence chat system 100 performs a role of providing necessary information to each other in conjunction with a chat application based on chatting documents between a user and a counterpart. In particular, the artificial intelligence chat system 100 may precisely recognize a variety of situations by providing the necessary information to each other based on the chatting documents between the user and the counterpart and may notify each other of appropriate information. Furthermore, the artificial intelligence chat system 100 may provide notification of an action that exerts a negative influence on the relation and may allow the user to reduce the action. In this case, to provide the necessary information, the artificial intelligence chat system 100 may be implemented with one system coupled to a social commerce system (not illustrated), which provides a product and a service, or a separate system, which is independent of the social commerce system, and may be implemented in the form of interworking with the artificial intelligence chat system 100.

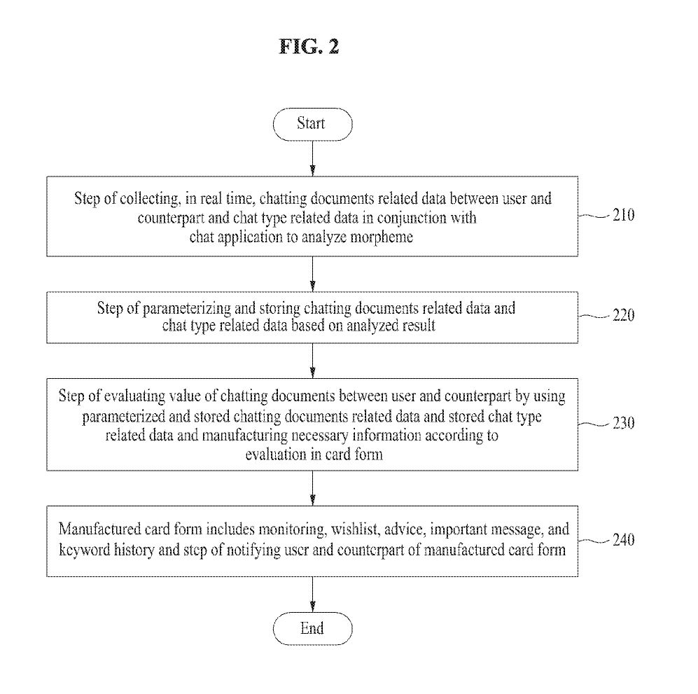

FIG. 2 is a flowchart for describing an artificial intelligence chat method of providing necessary information based on chatting documents, according to an embodiment of the inventive concept.

The artificial intelligence chat method for providing the necessary information based on the chatting documents may include step 210 of collecting, in real time, chatting documents related data between a user and a counterpart and chat type related data in conjunction with a chat application to analyze a morpheme, step 220 of parameterizing and storing the chatting documents related data and the chat type related data based on the analyzed result, step 230 of evaluating a value of the chatting documents between the user and the counterpart by using the parameterized and stored chatting documents related data and the parameterized and stored chat type and manufacturing the necessary information according to the evaluation in a card form that includes monitoring, a wishlist, an advice, an important message, and a keyword history, and step 240 of notifying the user and the counterpart of the manufactured card form.

In step 210, the artificial intelligence chat method may collect, in real time, the chatting documents related data between the user and the counterpart and the chat type related data in conjunction with a chat application to analyze a morpheme. In this case, the artificial intelligence chat method may collect, in real time, the chatting documents related data including a keyword, a tone, and a subject of the chatting documents between the user and the counterpart and the chat type related data including a response time and a message length of the chatting documents between the user and the counterpart to analyze each morpheme.

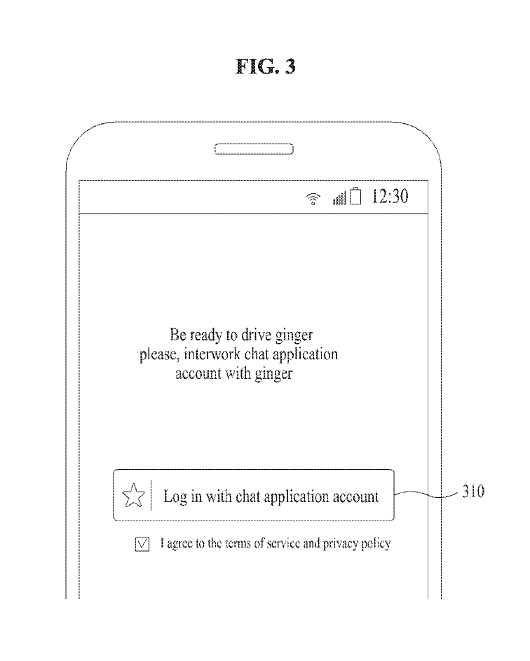

To collect the chatting documents related data and the chat type related data in real time, there is a need to interwork with the chat application. A process of interworking with the chat application will be described with reference to FIG. 3. Also, the artificial intelligence chat method for providing the necessary information based on the chatting documents may further include recommending the necessary information to the user and the counterpart by using the parameterized and stored chatting documents related data and the parameterized and stored chat type and providing the recommended information to the user or the counterpart in conjunction with social commerce. In this case, the artificial intelligence chat method may provide a user interface (UI) such that the user immediately purchases a product or presents the product to the counterpart based on the necessary information corresponding to a situation of the user and the counterpart and may interwork with the social commerce through the UI.

FIG. 3 is a drawing for describing a process of interworking with a chat application, according to an embodiment of the inventive concept.

Referring to FIG. 3, an example of the chat application is illustrated. A proposed artificial intelligence chat method for providing necessary information based on chatting documents may interwork with a preset chat application providing the chatting documents. For example, the chatting documents between a user and a counterpart may be received by performing login 310 with an account of the preset chat application and interworking with the proposed artificial intelligence chat method.

In addition, the artificial intelligence chat method may collect chatting documents related data between the user and the counterpart and chat type related data in real time based on the received chatting documents to analyze a morpheme. In this case, the artificial intelligence chat method may collect, in real time, the chatting documents related data including a keyword, a tone, and a subject of the chatting documents between the user and the counterpart and the chat type related data including a response time and a message length of the chatting documents between the user and the counterpart to analyze each morpheme.

In step 220, the artificial intelligence chat method may parameterize and store the chatting documents related data and the chat type related data based on the analyzed result. The artificial intelligence chat method may parameterize the chatting documents related data and the chat type related data into metadata based on the analyzed result and may store the metadata. For example, the metadata may include the chatting documents related data including a keyword, a tone, and a subject of the chatting documents between the user and the counterpart and the chat type related data including a response time and a message length of the chatting documents between the user and the counterpart.

In step 230, the artificial intelligence chat method may evaluate a value of the chatting documents between the user and the counterpart by using the parameterized and stored chatting documents related data and the parameterized and stored chat type and may manufacture the necessary information according to the evaluation in a card form.

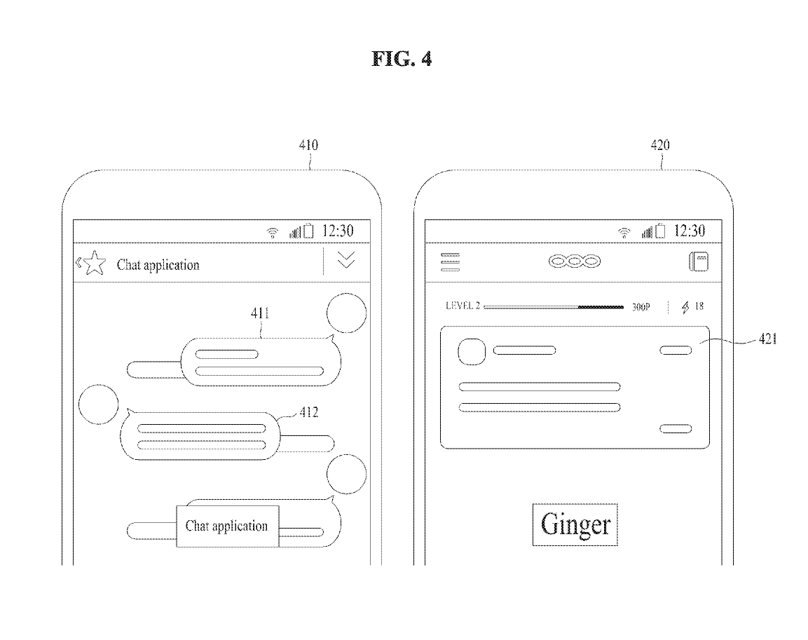

The artificial intelligence chat method may evaluate a value of a situation and a message between the user and the counterpart based on the parameterized and stored chatting documents related data and the parameterized and stored chat type and may recommend the necessary information corresponding to the situation. The artificial intelligence chat method may recognize the situation including conditions, feelings, and daily patterns of the user and the counterpart and may manufacture the necessary information corresponding to the situation in the card form. The artificial intelligence chat method will be described in detail with reference to FIG. 4.

FIG. 4 is a drawing for describing a process of manufacturing necessary information in a card form, according to an embodiment of the inventive concept.

Referring to FIG. 4, an application 420 through a proposed method may receive chatting documents 411 and 412 between a user and a counterpart in conjunction with a preset chat application 410. Furthermore, the application 420 may collect, in real time, chatting documents related data between the user and the counterpart and chat type related data based on the received chatting documents 411 and 412 to analyze a morpheme. In this case, the application 420 may collect, in real time, the chatting documents related data including a keyword, a tone, and a subject of the chatting documents 411 and 412 between the user and the counterpart and the chat type related data including a response time and a message length of the chatting documents between the user and the counterpart to analyze each morpheme. In addition, the application 420 may parameterize and store the chatting documents related data and the chat type related data based on the analyzed result.

The application 420 may recommend the necessary information, which the user and the counterpart want, by using the parameterized and stored chatting documents related data and the stored chat type related data. For example, the application 420 may recognize a situation including conditions, feelings, and daily patterns of the user and the counterpart and may manufacture the necessary information corresponding to the situation in a card form 421. Furthermore, the application 420 may notify the user and the counterpart of the necessary information in the graph form as well as the card form 421 and may recommend a product based on the necessary information. Through the method, the application 420 may automatically recognize a message included in the chatting documents between the user and the counterpart and may store the necessary information according to the message in a wishlist.

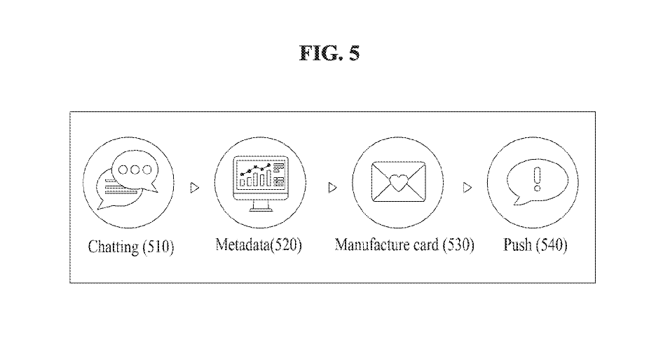

In step 240, the manufactured card form may include monitoring, a wishlist, an advice, an important message, and a keyword history service and may notify the user and the counterpart of the manufactured card form. A method of providing the manufactured card form and the necessary information will be described in detail with reference to FIGS. 5 to 9.

FIG. 5 is a drawing for describing a process of providing necessary information, according to an embodiment of the inventive concept.

First of all, the process may collect, in real time, chatting documents related data between a user and a counterpart and chat type related data in conjunction with a chat application (510). Also, the process may analyze a morpheme based on the collected data and may parameterize and store the chatting documents related data and the chat type related data based on the analyzed result. In other words, the process may parameterize the chatting documents related data and the chat type related data into metadata based on the analyzed result and may store the metadata (520). For example, the metadata may include the chatting documents related data including a keyword, a tone, and a subject of the chatting documents between the user and the counterpart and the chat type related data including a response time and a message length of the chatting documents between the user and the counterpart (520).

The process may recommend the necessary information, which the user and the counterpart want, by using the parameterized and stored chatting documents related data and the stored chat type related data. The process may recognize a situation including conditions, feelings, and daily patterns of the user and the counterpart and may manufacture the necessary information corresponding to the situation in a card form (530). In addition, the process may notify the user and the counterpart of the manufactured card through a push notification (540). The process may notify the user and the counterpart of the necessary information in the card form and various forms and may recommend a product according to the necessary information

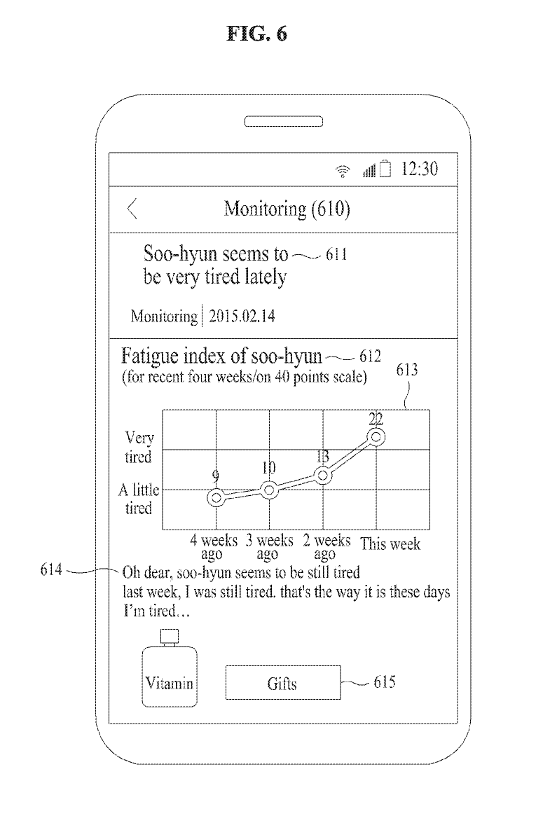

FIG. 6 is a drawing for describing a monitoring process, according to an embodiment of the inventive concept.

A proposed method may collect chatting documents related data between a user and a counterpart and chat type related data in real time in conjunction with a chat application to analyze a morpheme. In this case, the method may precisely recognize various situations, for example, conditions or feelings, drinking frequencies, sleep times, and the like of the user and the counterpart to notify each other of appropriate information. For example, if recognizing the fact that the counterpart was recently very busy, the method may advise the user to give the counterpart a vitamin drink.

Referring to FIG. 6, a result of monitoring 610 of the various situations, for example, conditions or feelings, drinking frequencies, sleep times, and the like of the user and the counterpart is illustrated.

For example, in the case where a schedule of Soo-hyun (counterpart) is tight or in the case where Soo-hyun sleeps late, the method may manufacture a card 611 and may notify the user of a monitoring result. Moreover, a fatigue index 612 of Soo-hyun (counterpart) may be expressed in a graph form 613 every week. The monitoring result may be expressed in a message form 614, and a UI for providing a gift based on a situation may be expressed. In the case where a condition of Soo-hyun (counterpart) is determined as a fatigue because the schedule of Soo-hyun (counterpart) is tight, the method may express a ‘Gifts’ UI 615 such that Soo-hyun (counterpart) gifts a vitamin to the user. In addition, in the case where the user touches the UI, the method may connect with social commerce and may allow the user to buy a corresponding product.

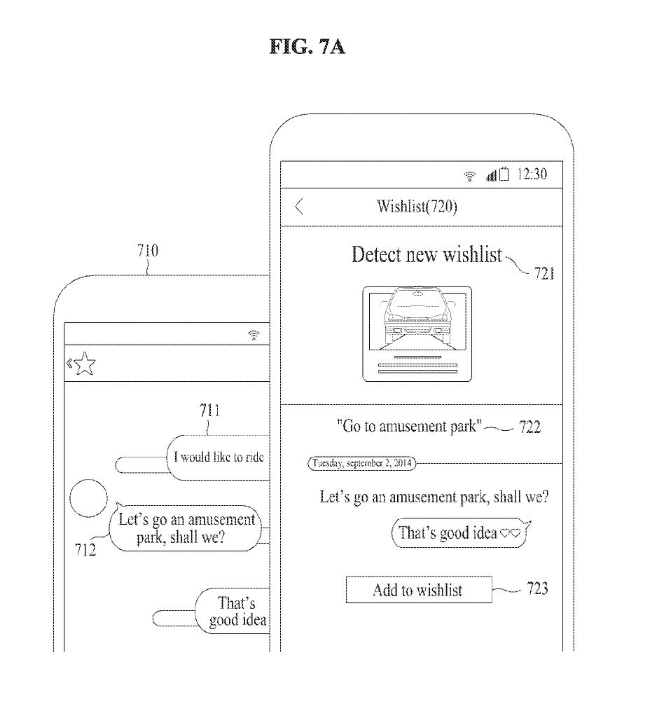

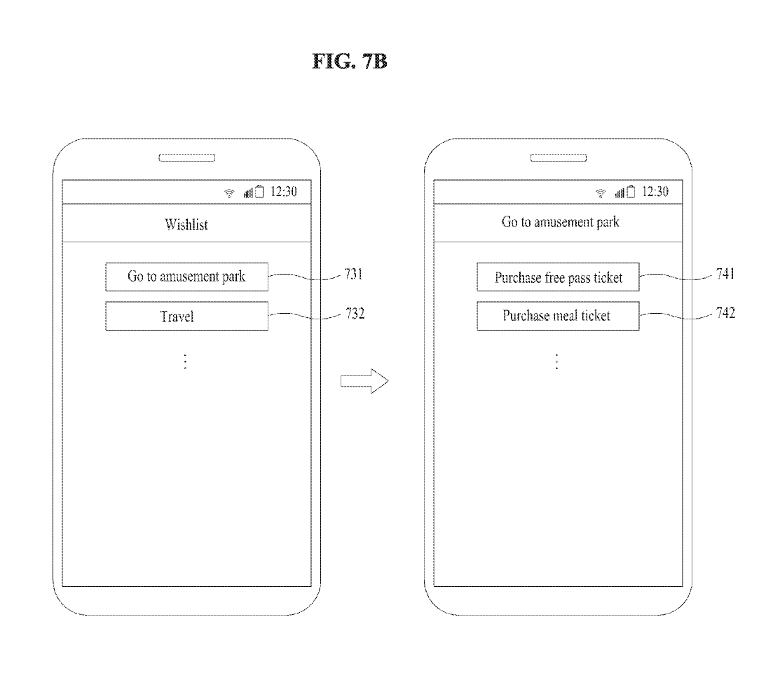

FIG. 7 is a drawing for describing a process of storing a wishlist, according to an embodiment of the inventive concept.

FIG. 7A is a drawing for describing the process of storing the wishlist.

As described above, the process may collect chatting documents related data between a user and a counterpart and chat type related data 711 and 712 in real time, in conjunction with a chat application 710, to analyze a morpheme and may recognize a situation based on the analyzed result. The wishlist may recognize a message having wish information including a place where the user and the counterpart want to go, food that the user and the counterpart want to eat, and a task, which the user and the counterpart want to do, based on the parameterized and stored chatting documents related data and the parameterized and stored chat type 711 and 712 and may store the wish information in the wishlist. In addition, the process may recommend a product or a service corresponding to the situation. The recommended product or service may be stored in a wishlist 720.

For example, in the case where a text associated with an amusement park is detected in the chatting documents by analyzing the chatting documents related data between the user and the counterpart and the chat type related data, the process may manufacture a card called ‘Detect new wish’ 721, and ‘Go to amusement park’ 722 may be added in the wishlist 720. The wishlist thus generated may be added by touching a UI of an ‘Add to wishlist’ 723.

FIG. 7B is a drawing illustrating a stored wishlist.

As described in FIG. 7A, if a user clicks an ‘Add to wishlist’ 723, a corresponding text may be stored in the wishlist. Referring to FIG. 7B, the process may check that a wishlist of ‘Go to amusement park’ 731, Travel 732, or the like is stored in the wishlist.

If the user touches ‘Go to amusement park’ 731 in the wishlist, a product and a service associated with the amusement park may be displayed. For example, the process may display a UI of ‘Purchase free pass ticket’ 741, ‘Purchase meal ticket’ 742, or the like, which is used at an amusement park, and if the user touches UI that the user wants, the user may directly purchase a corresponding product and a corresponding service in conjunction with social commerce.

The chat application may provide accumulated one-to-one chatting documents between the user and the counterpart. Furthermore, the proposed method may collect the chatting documents related data and the chat type related data based on the accumulated one-to-one chatting documents received from the chat application and may update the collected data in real time.

The social commerce may provide a product and a service according to necessary information corresponding to a situation between the user and the counterpart. Furthermore, through the proposed method, the user and the counterpart may access the product and the service, which are received from the social commerce, through the UI.

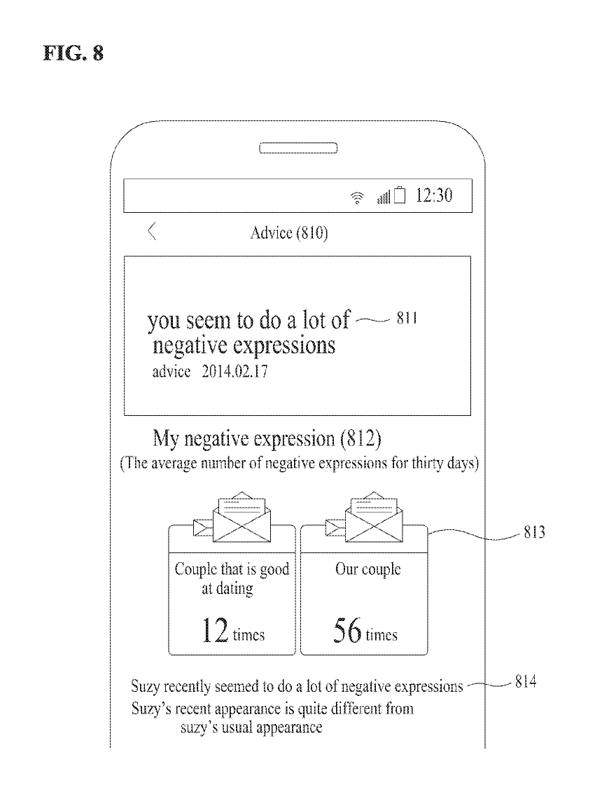

FIG. 8 is a drawing for describing a process of providing an advice service, according to an embodiment of the inventive concept.

The process may collect chatting documents related data between a user and a counterpart and chat type related data in real time to analyze a morpheme and may recognize a situation based on the analyzed result. A service of an advice 810 may recognize negative information, which exerts a negative influence on a relation between the user and the counterpart, based on the parameterized and stored chatting documents related data and the parameterized and stored chat type and may allow the user to reduce a mention of the negative information.

For example, in the case where a message that exerts the negative influence on the relation, in the chatting documents is detected by analyzing the chatting documents related data between the user and the counterpart and the chat type related data, the process may allow the user to reduce the action. If there are a lot of expressions of “it's hard”, “it's annoying”, and the like in the message, the negative influence on the relation may be exerted. Accordingly, a change may be induced while data of the user about on the actions is actually displayed.

The proposed artificial intelligence chat method for providing necessary information based on the chatting documents may manufacture a card 811 of the negative message, may notify the user of a negative expression 812 of the user, and may express a comparison data 813 of other users. An advice on the negative message may be expressed as a message form 814.

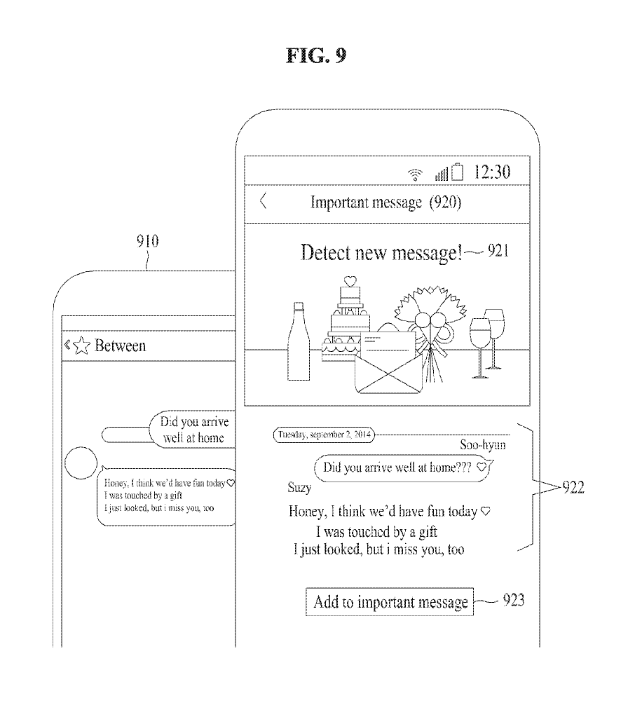

FIG. 9 is a drawing for describing a process of providing an important message service, according to an embodiment of the inventive concept.

As described above, the process may collect chatting documents related data between a user and a counterpart and chat type related data in real time, in conjunction with a chat application 910, to analyze a morpheme and may recognize a situation based on the analyzed result. A service of an important message 920 may store a message, which is worthy of storage, as an important message if a message 922 between the user and the counterpart, which is worthy of storage, is sent and received based on the parameterized and stored chatting documents related data and the stored chat type related data.

For example, in the case where a message 922, which is romantic enough for the counterpart to want to store it, the service of the important message 920 may automatically recognize the message 922 and may store the message 922 as the important message 920. In this case, the service of the important message 920 may manufacture a card, which is called ‘Detect new message’ 921 and may add the message to the important message 920. The important message 920 thus generated may be added by touching a UI of ‘Add to important message’ 923.

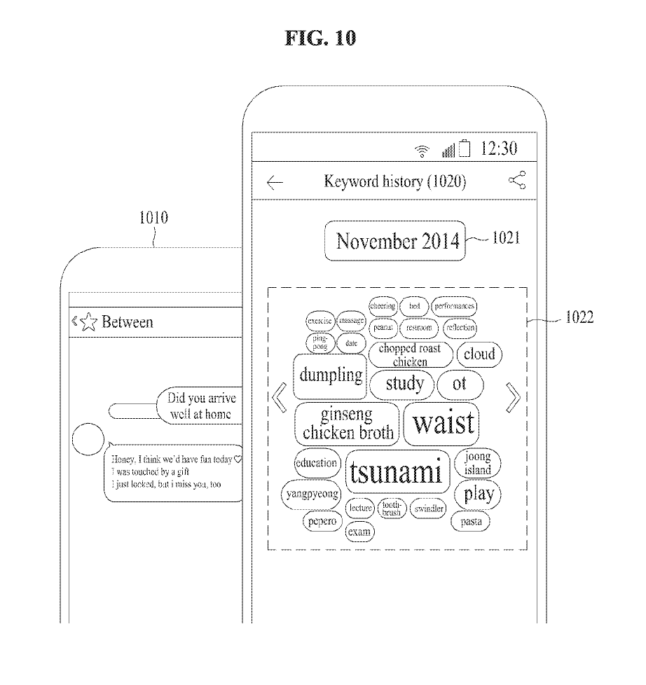

FIG. 10 is a drawing for describing a process of providing a keyword history service, according to an embodiment of the inventive concept.

As described above, the process may collect chatting documents related data between a user and a counterpart and chat type related data in real time, in conjunction with a chat application 1010, to analyze a morpheme and may recognize a situation based on the analyzed result. A service of a keyword history 1020 may recognize a subject of a message between the user and the counterpart based on the parameterized and stored chatting documents related data and the parameterized and stored chat type and may arrange and store the subject for each preset interval.

For example, the service of the keyword history 1020 may recognize a subject 1022 in the chatting documents by analyzing the chatting documents related data between the user and the counterpart and the chat type related data and may arrange the subject 1022 for each month 1021. If the user looks at a screen of the keyword history 1020, the user may know what happens to the user and the counterpart this month and what to talk about with the user and the counterpart. Accordingly, the user and the counterpart may understand, at a time, a record from starting dating to now over the years.

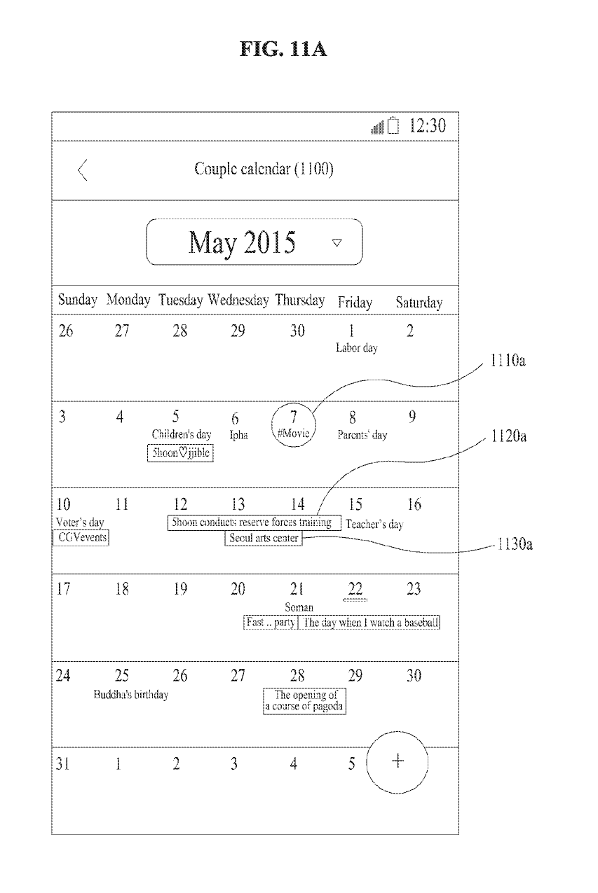

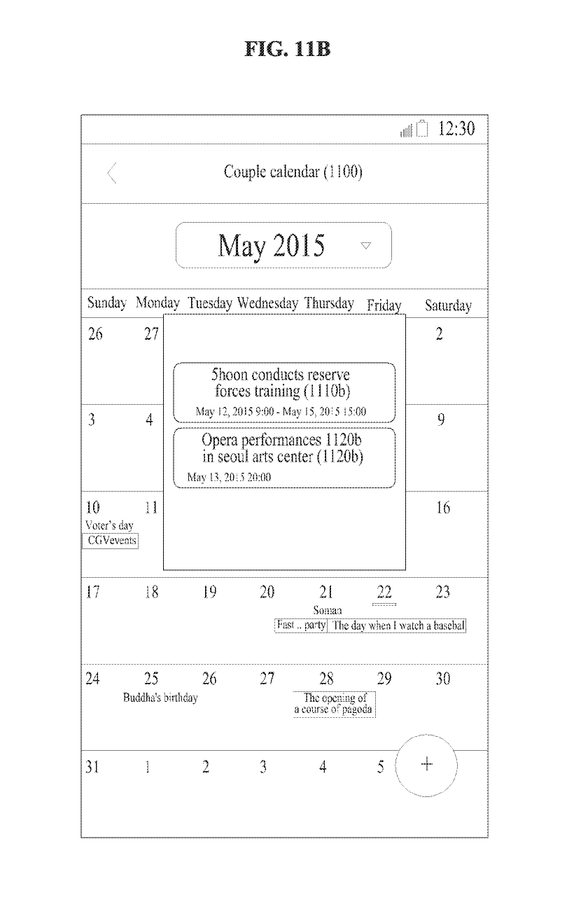

FIG. 11 is a drawing for describing a process of providing a schedule service, according to an embodiment of the inventive concept.

The schedule service may recognize a schedule from a message between a user and a counterpart based on parameterized and stored chatting documents related data and stored chat type related data and may arrange and store the schedule.

Referring to FIG. 11A, the schedule service may collect the chatting documents related data between the user and the counterpart and the chat type related data in real time, in conjunction with a chat application, to analyze a morpheme and may recognize a situation based on the analyzed result. The schedule service may recognize the schedule from the message between the user and the counterpart based on the parameterized and stored chatting documents related data and the parameterized and stored chat type and may arrange and store the schedule in a couple calendar 1100.

For example, the schedule service may recognize a text associated with the schedule in the chatting documents by analyzing the chatting documents related data between the user and the counterpart and the chat type related data, may automatically recognize a day when the user and counterpart met, may store the day in the couple calendar 1100, and may recommend a tag, which is added to a memo, by analyzing the chatting documents.

For example, the schedule service may recognize that two persons are met on Thursday, May 7, through the chatting documents. If the two persons talk about a movie on the previous day, the schedule service may recommend a word, which is called ‘movie’ 1110a, as the tag of a calendar of May 7. Furthermore, in the case where a text of reserve forces training 1120a from May 12 to May 14 is recognized in the chatting documents, the schedule service may store the text in the couple calendar 1100. Also, in the case where a text about watching opera performances in Seoul Arts Center on May 13 is recognized in the chatting documents, the schedule service may store the text in the couple calendar 1100.

In addition, if the user clicks a corresponding date on the couple calendar 1100, the user may check details as illustrated in FIG. 11B. For example, in the case where the user clicks May 13, the user may check details about reserve forces training 1110b and opera performances 1120b in Seoul Arts Center.

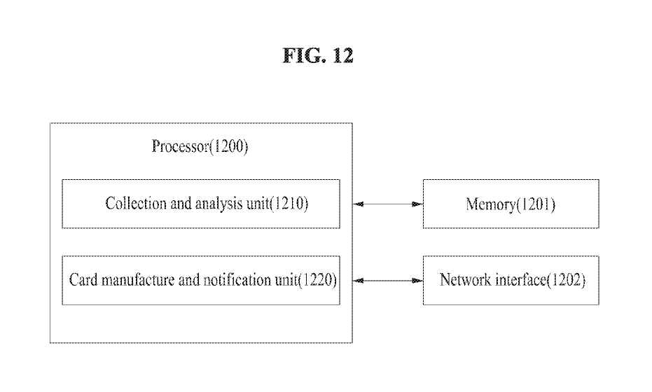

FIG. 12 is a drawing illustrating a configuration of an artificial intelligence chat system providing necessary information based on chatting documents, according to an embodiment of the inventive concept.

As illustrated in FIG. 12, the artificial intelligence chat system providing the necessary information through social commerce may be configured to include a processor 1200 composed of a collection and analysis unit 1210 and a card manufacture and notification unit 1220, a memory 1201, and a network interface 1202.

The memory 1201 may store an operating system (OS) and a program including an instruction corresponding to an artificial intelligence chat service routine. An artificial intelligence chat service may recognize a variety of situations by providing the necessary information to each other based on the chatting documents between a user and a counterpart and may provide appropriate information to each other. Each of steps performed at the artificial intelligence chat system described with reference to FIGS. 1 to 10 may be executed by the program stored in the memory 1201. For example, the memory 1201 may be a hard disk, a solid state disk (SDD), a secure digital (SD) card, or another storing medium.

To communicate with user terminals using the artificial intelligence chat service, the network interface 1202 may combine the artificial intelligence chat system with a network.

The processor 1200 may be a device for performing a processing operation according to an instruction of the program stored in the memory 1201 and may include a microprocessor such as a central processor unit (CPU). A description will be given of detailed elements of the processor 1200.

The collection and analysis unit 1210 may collect, in real time, chatting documents related data between the user and the counterpart and chat type related data in conjunction with a chat application to analyze a morpheme. In this case, the collection and analysis unit 1210 may collect, in real time, the chatting documents related data including a keyword, a tone, and a subject of the chatting documents between the user and the counterpart and the chat type related data including a response time and a message length of the chatting documents between the user and the counterpart to analyze each morpheme.

To collect the chatting documents related data and the chat type related data in real time, there is a need to interwork with the chat application.

In addition, the collection and analysis unit 1210 may parameterize and store the chatting documents related data and the chat type related data based on the analyzed result. The collection and analysis unit 1210 may parameterize the chatting documents related data and the chat type related data into metadata based on the analyzed result and may store the metadata. For example, the metadata may include the chatting documents related data including a keyword, a tone, and a subject of the chatting documents between the user and the counterpart and the chat type related data including a response time and a message length of the chatting documents between the user and the counterpart.

The card manufacture and notification unit 1220 may recommend the necessary information, which the user and the counterpart want, by using the parameterized and stored chatting documents related data and the stored chat type related data. The card manufacture and notification unit 1220 may evaluate a value of a situation and a message between the user and the counterpart based on the parameterized and stored chatting documents related data and the parameterized and stored chat type and may recommend the necessary information corresponding to the situation.

The card manufacture and notification unit 1220 may recognize the situation including conditions, feelings, and daily patterns of the user and the counterpart and may manufacture the necessary information corresponding to the situation in the card form. The card manufacture and notification unit 1220 may notify the user and the counterpart of the necessary information in the card form and a graph form and may recommend a product according to the necessary information. Moreover, the card manufacture and notification unit 1220 may automatically recognize a message included in the chatting documents between the user and the counterpart and may store the necessary information according to the message in a wishlist.

In addition, the manufactured card form may include a monitoring service, a wishlist service, an advice service, an important message service, and a keyword history service and may notify the user and the counterpart of the manufactured card form.

The monitoring service may recognize situation information including conditions, feelings, and daily patterns of the user and the counterpart based on the parameterized and stored chatting documents related data and the parameterized and stored chat type and may provide the necessary information corresponding to the situation information.

The wishlist service may recognize a message having wish information including a place where the user and the counterpart want to go, food that the user and the counterpart want to eat, and a task, which the user and the counterpart want to do, based on the parameterized and stored chatting documents related data and the parameterized and stored chat type and may store the wish information in the wishlist.

The advice service may recognize negative information, which exerts a negative influence on a relation between the user and the counterpart, based on parameterized and stored chatting documents related data and stored chat type related data and may allow the user to reduce a mention of the negative information.

The important message service may store a message, which is worthy of storage, as an important message if a message between the user and the counterpart, which is worthy of storage, is sent and received based on the parameterized and stored chatting documents related data and the stored chat type related data.

The keyword history service may recognize a subject of a message between the user and the counterpart based on the parameterized and stored chatting documents related data and the parameterized and stored chat type and may arrange and store the subject for each preset interval.

Moreover, the recommended information may be provided to the user or the counterpart in conjunction with the social commerce. The processor may provide a UI such that the user immediately purchases a product or presents the product to the counterpart based on the necessary information corresponding to the situation of the user and the counterpart. In this case, the processor may provide the UI such that the user immediately purchases a product or presents the product to the counterpart and may interwork with the social commerce through the UI.

The foregoing devices may be realized by hardware elements, software elements and/or combinations thereof. For example, the devices and components illustrated in the exemplary embodiments of the inventive concept may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A processing unit may implement an operating system (OS) or one or software applications running on the OS. Further, the processing unit may access, store, manipulate, process and generate data in response to execution of software.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implements, other embodiments, and equivalents to claims are within the scope of the following claims.

What is claimed is:

1. An artificial intelligence chat method for providing necessary information based on chatting documents, the method comprising:
collecting, in real time, chatting documents related data between a user and a counterpart and chat type related data in conjunction with a chat application to analyze a morpheme of the chatting documents related data;
parameterizing and storing the chatting documents related data and the chat type related data based on the analyzed result;
evaluating a value of the chatting documents between the user and the counterpart by using the parameterized and stored chatting documents related data and the stored chat type related data and manufacturing the necessary information according to the evaluation in a card form, the manufactured card form comprising monitoring, a wishlist, an advice, an important message, a keyword history, and a schedule; and
notifying the user and the counterpart of the manufactured card form.

2. The method of claim 1, wherein the monitoring recognizes situation information comprising conditions, feelings, and daily patterns of the user and the counterpart based on the parameterized and stored chatting documents related data and the parameterized and stored chat type and provides the necessary information corresponding to the situation information.

3. The method of claim 1, wherein the wishlist service recognizes a message having wish information comprising a place where the user and the counterpart want to go, food that the user and the counterpart want to eat, and a task, which the user and the counterpart want to do, based on the parameterized and stored chatting documents related data and the parameterized and stored chat type and stores the wish information in the wishlist service.

4. The method of claim 1, wherein the advice service recognizes negative information that exerts a negative influence on a relation between the user and the counterpart based on the parameterized and stored chatting documents related data and the parameterized and stored chat type and allows the user to reduce a mention of the negative information.

5. The method of claim 1, wherein the important message service stores a message, which is worthy of storage, as an important message service if the message between the user and the counterpart, which is worthy of storage, is sent and received based on the parameterized and stored chatting documents related data and the stored chat type related data.

6. The method of claim 1, wherein the keyword history recognizes a subject of a message between the user and the counterpart based on the parameterized and stored chatting documents related data and the parameterized and stored chat type and arranges and stores the subject for each preset interval.

7. The method of claim 1, wherein the schedule service recognizes a schedule from a message between the user and the counterpart based on the parameterized and stored chatting documents related data and the parameterized and stored chat type and arranges and stores the schedule.

8. The method of claim 1, the method further comprising:
collecting, in real time, the chatting documents related data comprising a keyword, a tone, and a subject of the chatting documents between the user and the counterpart and the chat type related data comprising a response time and a message length of the chatting documents between the user and the counterpart and analyzing each morpheme.

9. The method of claim 1, the method further comprising:
parameterizing the chatting documents related data and the chat type related data into metadata based on the analyzed result and storing the metadata.

10. The method of claim 1, further comprising:
recommending the necessary information to the user and the counterpart by using the parameterized and stored chatting documents related data and the stored chat type related data; and
providing the recommended information to the user or the counterpart in conjunction with social commerce.

11. The method of claim 10, wherein the providing of the recommended information to the user or the counterpart in conjunction with the social commerce comprises:
providing a user interface (UI) such that the user immediately purchases a product or presents the product to the counterpart based on the necessary information corresponding to a situation of the user and the counterpart; and
interworking with the social commerce through the UI.
